(19) United States
(12) Patent Application Publication
(10) Pub. No.: US 2025/0347463 A1
(43) Pub. Date: Nov. 13, 2025

(54) INSTALLATION COMPRISING LNG AND RENEWABLE ELECTRICITY FACILITIES WITH AT LEAST ONE THERMAL ENERGY STORAGE SYSTEM

(71) Applicant: TotalEnergies OneTech, COURBEVOIE (FR)

(72) Inventors: Patrick HAVIL, BOULOGNE-BILLANCOURT (FR); Clément NAVARRO, St Jean Lherm (FR); Walter Josephus VERMEIREN, Houthalen-Helchteren (BE); Thierry GORILLIOT, BOIS D’ARCY (FR)

(73) Assignee: TotalEnergies OneTech, COURBEVOIE (FR)

(21) Appl. No.: 18/868,835

(22) PCT Filed: May 31, 2023
(86) PCT No.: PCT/EP2023/064480

§ 371 Date: Nov. 25, 2024

(30) Foreign Application Priority Data
Jun. 1, 2022 (EP) 22305802.5

(51) Int. Cl. F25J 1/00

(52) U.S. Cl. CPC F25J 1/0022

(57) ABSTRACT

An installation comprising an LNG production facility, and a renewable electricity facility for producing renewable electricity, the LNG production facility comprising:
a plurality of units,
at least one thermal energy storage system for storing electricity as thermal energy, and for converting at least part of the stored thermal energy into electricity, heat and/or cold.

The installation is adapted for switching between a charge configuration, wherein the renewable electricity facility produces said renewable electricity stored in the thermal energy storage system and supplied to one or several of the units, and a discharge configuration, wherein the thermal energy storage system converts some of the stored thermal energy into at least one of said electricity, heat or cold, for supplying one or several of the units.

### CROSS REFERENCE TO RELATED APPLICATIONS

The present application is a U.S. National Phase Application under 35 U.S.C. § 371 of International Patent Application No. PCT/EP2023/064480 filed May 31, 2023, which claims priority of European Patent Application No. 22305802.5 filed Jun. 1, 2022. The entire contents of which are hereby incorporated by reference.

### FIELD OF THE INVENTION

The present invention deals with an installation comprising an LNG production facility adapted for producing liquefied natural gas from a feed gas containing methane.

The invention also deals with a corresponding process of producing liquefied natural gas from a feed gas containing methane.

### BACKGROUND

LNG stands for liquefied natural gas, and is natural gas (mostly methane) that has been cooled down to approximately −162° C. to liquid form at near ambient pressure.

An LNG production facility generally includes a purification unit, an acid gas (such as hydrogen sulphide (H₂S) and carbon dioxide (CO₂)) removal unit, a water removal unit and mercury removal unit in order to purify the feed gas, natural gas liquid separation (methane separation from C2+) and a precooling unit and a liquefaction unit in order to liquefy the purified natural gas and fractionating the different components in the gas, usually including methane (CH₄), ethane (C₂H₆), propane (C₃H₈), butane (C₄H₁₀) and liquid hydrocarbons, commonly known as NGL (natural gas liquids). Once natural gas has been pretreated to reduce the impurities to trace levels—i.e., water to 0.1 ppm, CO₂ to 50 ppm and Hg to less than 10 ng/Nm3—LNG is liquefied and subcooled by cooling the gas to −162° C. (at 1 bar abs). An LNG production facility consumes a rather steady amount of electricity, mainly for powering purification systems, and compressors in the refrigeration cycle(s) of the precooling and liquefaction units.

This electricity is obtained from the grid and/or produced locally, for example using gas turbines. As a result, the electricity production is associated with some fossil fuels, hence with CO2 emissions, whether local or global.

In order to decarbonize the LNG production, it is desirable to produce the largest possible fraction of the electricity using renewable electricity production facilities, based on energy sources such as sunlight, wind, geothermal, waves and tides.

However, some of these energy sources are not constant and is by nature intermittent. A solar power plant does not produce at night or in case of bad weather. Wind is also not permanent, or sometimes too strong to allow windmills to operate. Tides are periodic.

As a consequence, an LNG production facility cannot fully rely only on renewable electricity produced locally. At best, renewable electricity accounts for a modest fraction of the consumed electricity amount.

One solution could consist in storing renewable electricity locally in order to use it on a more constant basis. However, storages using gravity related potential energy, involving pumping water upstream a dam or raising a huge mass, are difficult to implement, location dependent and expensive. Batteries providing electrochemical storage, such as the lithium-ions ones, are not adapted for storing energy for more than six hours. Indeed, this would require a certain storage capacity, with high related costs. Moreover, in batteries the power and amount of energy stored are linked, providing no flexibility regarding the amount of energy required. They also raise environmental concerns due to their consumption of rare elements, and appear tricky to recycle.

As a consequence, the decarbonization of LNG production facilities remains modest.

### SUMMARY

An aim of the invention is to achieve a better decarbonization of an LNG production facility.

To this end, the invention proposes an installation comprising an LNG production facility adapted for producing liquefied natural gas from a feed gas containing methane, and a renewable electricity facility adapted for producing renewable electricity, the LNG production facility comprising:
a plurality of units including a precooling unit, and a liquefaction unit, and
at least one thermal energy storage system adapted for storing electricity as thermal energy, and for converting at least part of the stored thermal energy into electricity, heat and/or cold,
wherein the installation is adapted for switching at least between a charge configuration, in which the renewable electricity facility produces said renewable electricity, at least a fraction of said renewable electricity is stored in the thermal energy storage system as thermal energy and at least another fraction is supplied to one or several of the units, and a discharge configuration, in which the thermal energy storage system converts at least part of the stored thermal energy into at least one of said electricity, said heat and said cold and said at least one of said electricity, said heat and said cold is supplied to one or several of the units.

In other embodiments, the installation comprises one or several of the following features, taken in isolation or any technically feasible combination:
the thermal energy storage system is a Carnot battery and is adapted, in the discharge configuration, for converting at least part of the stored thermal energy into at least said electricity;
the thermal energy storage system is adapted, in the charge configuration, for receiving fatal heat from at least one of said units;
the thermal energy storage system is adapted, in the discharge configuration, for converting at least part of the stored thermal energy into steam and the installation is adapted for providing said steam to a steam turbine of one of said units;
at least one coupling heat exchanger connected to the thermal energy storage system for receiving a working fluid, and connected to at least one of said units for receiving a process fluid, the coupling heat exchanger being adapted for performing a heat exchange between the working fluid and the process fluid for supplying said heat or said cold;
the plurality of units comprises a purification unit, a water removal unit, an acid gas removal unit and a fractionation unit, wherein, in the coupling heat exchanger, the process fluid comes from the purification unit, the water removal unit, the acid gas removal unit or the fractionation unit and receives the heat from the working fluid;
the LNG production facility comprises a refrigeration cycle, for example using propane as a refrigerant, in order to bring cold at least to the precooling unit, wherein, in the coupling heat exchanger, the process fluid comes from said refrigeration cycle and receives the cold from the working fluid;
the LNG production facility comprises a refrigeration cycle, for example using a mixed refrigerant chilled in the precooling unit, in order to bring cold at least to the liquefaction unit, wherein, in the at least one coupling heat exchanger, the process fluid comes from said refrigeration cycle and receives the cold from the working fluid; and
the at least one coupling heat exchanger, the process fluid is natural gas obtained by purification of the feed gas, and receives the cold from the working fluid.

The invention also deals with a process of producing liquefied natural gas from a feed gas containing methane, comprising:
providing an installation as described by any the invention,
producing the liquefied natural gas from the feed gas using the LNG production facility,
switching the installation at least between the charge configuration, and the discharge configuration.

### BRIEF DESCRIPTION OF THE DRAWINGS

The invention and its advantages will be better understood upon reading the following description, given solely by way of example and with reference to the appended drawings, in which:

FIG. 1 is a schematic view of an installation according to the invention,

FIG. 2 is a schematic view of the thermal energy storage system and of a portion of the LNG production facility shown in FIG. 1, and

FIG. 3 is a schematic view of the precooling and liquefaction units shown in FIG. 1.

### DETAILED DESCRIPTION

### Installation

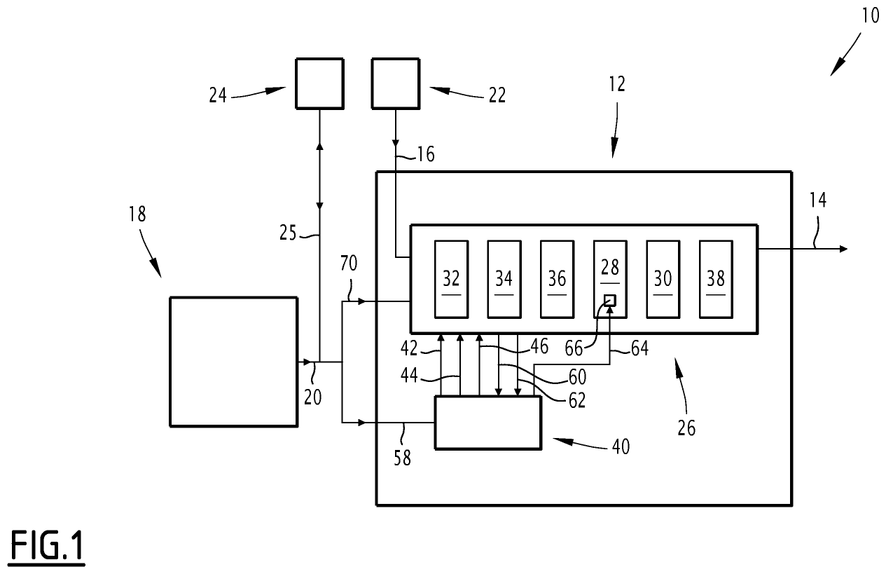

With reference to FIG. 1, an installation 10 according to the invention will be described.

The installation 10 comprises an LNG production facility 12 adapted for producing liquefied natural gas 14 (or LNG) from a feed gas 16 containing methane, and a renewable electricity facility 18 adapted for producing renewable electricity 20.

The liquefied natural gas 14 for example contains at least 80 wt % of methane.

The installation 10 is for example connected to a source of gas 22 for receiving the feed gas 16, and advantageously to a grid 24 for receiving additional electricity 25 or supplying electricity to the grid.

The feed gas 16 is for example raw gas, comprising a mix of hydrocarbon compounds, as well as water and acid gases.

As a variant, the feed gas 16 is a purified gas, in which water and acid gases have been removed.

The installation 10 is adapted for switching at least between a charge configuration and a discharge configuration regarding energy supply for operating the LNG production facility 12. Those configurations will be described later.

The renewable electricity facility 18 is for example a solar power plant and/or a wind farm.

### LNG facility

Once natural gas has been pretreated to reduce the impurities to trace levels, i.e., water to 0.1 ppm, CO₂ to 50 ppm and Hg to less than 10 ng/Nm³, LNG is liquefied and subcooled by cooling the gas to −162° C. (at 1 bar abs). The refrigerant fluid can be a single-component fluid (N₂, for instance) or a mixture of light hydrocarbons, generally termed as mixed refrigerant (MR).

In the inverted Brayton cycle, the cooling duty is provided by expanding nitrogen through a Joule-Thomson valve or an expander, without causing a change in the fluid state. The pressure of N₂ is raised with a compressor and cooled at constant pressure. In the following isentropic expansion, the temperature drops, providing the cooling stream against which natural gas can be cooled and liquefied:

In the compression refrigeration cycle (CRC), heat is extracted from a process stream by evaporating, at low pressure, the refrigerant fluid in a heat exchanger and rejecting heat by condensing the refrigerant vapor at relatively high temperature. The rejection is accomplished by transferring the extracted heat to an external utility or to a heat sink within the process, or to another refrigeration system (cascade refrigeration). The simplest refrigeration closed cycle (“Closed cycle” means that the working fluid of the refrigeration system is permanently contained within the mechanical system) entails a sequence of evaporation (heat extraction at low pressure), compression, condensation (heat rejection at high pressure) and expansion. In case of a single refrigerant, the fluid must be compressed and expanded to pressures low enough to reach a temperature colder than the process stream. Since natural gas is a mixture of components, its condensation curve (the plot of temperature against specific enthalpy (J/kg)) progressively decreases over the entire enthalpy domain and hence the thermodynamic efficiency lowers when attempting to match the discrete single-refrigerant temperature levels with the condensation curve of process streams.

The thermodynamic efficiency of the basic closed cycle can be improved by increasing the number of refrigeration stages or by using more than a single working fluid (refrigerant) in a cascade arrangement. In the cascade arrangement, two or more refrigerant fluids (generally propane and ethane) are used in two distinct refrigeration cycles. The low-temperature cycle provides the cooling in the evaporator and rejects heat to the other cycle by means of the evaporator/condenser heat exchanger. Mixed refrigerants are being used to reach even a better approach of the boiling curve of a designed mixture of refrigeration fluid to the natural gas cooling curve and hence less external work is required for the liquefaction. Mixed refrigerants are used for liquefying natural gas that generally contains methane, ethane, propane and nitrogen.

A number of liquefaction systems for cooling, liquefying, and optionally sub-cooling natural gas are well known in the art, such as the single mixed refrigerant (SMR) cycle, propane pre-cooled mixed refrigerant (C3MR) cycle, dual mixed refrigerant (DMR) cycle, C3MR-Nitrogen hybrid (such as the AP-X® process) cycles, nitrogen or methane expander cycle, and cascade cycles. Typically, in such systems, natural gas is cooled, liquefied, and optionally sub-cooled by indirect heat exchange with one or more refrigerants. A variety of refrigerants might be employed, such as mixed refrigerants, pure components, two-phase refrigerants, gas phase refrigerants, etc. Mixed refrigerants (MR), which are a mixture of nitrogen, methane, ethane/ethylene, propane, butanes, and optionally pentanes, have been used in many base-load liquefied natural gas (LNG) plants. The composition of the MR stream is typically optimized based on the feed gas composition and operating conditions.

The refrigerant is circulated in a refrigerant circuit that includes one or more heat exchangers and one or more refrigerant compression systems. The refrigerant circuit may be closed-loop or open-loop. Natural gas is cooled, liquefied, and/or sub-cooled by indirect heat exchange against the refrigerants in the heat exchangers.

Each refrigerant compression system includes a compressing step, equipped with a driver assembly to provide the power needed to drive the compressors, for compressing to high pressure followed by cooling the circulating refrigerant to produce a liquid refrigerant, prior to expansion in order to produce a cold low pressure refrigerant stream that provides the heat/cold duty necessary to cool, liquefy, and optionally sub-cool the natural gas. Various heat exchangers may be employed for natural gas cooling and liquefaction service. Coil Wound Heat Exchangers (CWHEs) are often employed for natural gas liquefaction. CWHEs typically contain helically wound tube bundles housed within an aluminum or stainless-steel pressurized shell.

In the baseload LNG industry, the most commonly used process configuration is a combination of propane precooled and mixed refrigeration (C3MR) processes in two refrigeration loops. Generally, the propane cycle includes a three-stage refrigeration system where propane is boiled at three distinct temperature levels and the boiling curve forms three distinct steps. Natural gas is fed to the precooling section where is it cooled from ambient temperatures to approximately −35° C. by a three-stage propane refrigeration loop. The pre-cooled feed gas then enters the coil wound heat exchanger (CWHE) where natural gas is liquefied using a mixed refrigerant (MR) which is a combination of nitrogen, methane, ethane, and propane. Finally, the LNG exits the cold end of the MCHE and piped to the LNG storage tank. In the MR refrigeration loop, the high-pressure MR is cooled by propane to approximately −35° C. where it partially condenses. The MR is separated in the high-pressure MR separator into MR liquid (MRL) and MR vapor (MRV). The MRL enters the warm end of the MCHE, where it is subcooled. The MRL is removed at an intermediate point of the MCHE, reduced in pressure and sent to the MCHE shell side. The MRV enters the warm end of the MCHE where it is liquefied and subcooled. The MRV exits the cold end of the MCHE before being reduced in pressure and returned to the shell side. The MRV and MRL boil on the shell side, providing the refrigeration to liquefy and subcool the incoming natural gas and MR. Superheated vapor MR exits the warm end of the MCHE before being compressed in a two-stage compressor, consisting of a Low Pressure (LP) and High Pressure (HP) MR compressor stage and returned back to the pre-cooling unit propane refrigeration loop.

The embodiments of the present invention can be applied to any LNG liquefaction process in which there is at least a pretreatment, fractionation, liquefaction section followed by a subcooling section. For example, it can be applied to double or dual mixed refrigerant (DMR) and hybrid C3MR pre-cooling and liquefaction with nitrogen expander cycle LNG subcooling (AP-X™) processes as well as the illustrated C3MR process.

As shown in FIG. 1, the LNG production facility 12 comprises a plurality of units 26, including a precooling unit 28, and a liquefaction unit 30. As the feed gas 16 is a raw gas in the example, the LNG production facility 12 also includes a purification unit 32 for example to remove liquids, a water removal unit 34, and an acid gas removal unit 36. The LNG production facility 12 may also include a fractionation unit 38 for fractionating natural gas liquids (ethane, propane, butanes and other liquids).

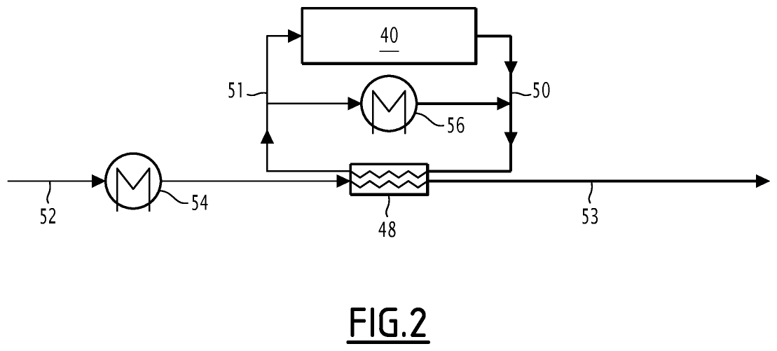

The LNG production facility 12 comprises at least one thermal energy storage system 40 adapted for storing electricity as thermal energy, and for converting at least part of the stored thermal energy into electricity 42, heat 44 and/or cold 46. In particular embodiments, the LNG production facility 12 may comprise several thermal energy storage systems (of which only one is shown in FIGS. 1 and 2).

As shown in FIG. 2, the LNG production facility 12 advantageously comprises at least one coupling heat exchanger 48 connected to the thermal energy storage system 40 for receiving a working fluid 50 (hot or cold), and to at least one unit of the units 26 for receiving a process fluid 52 from said unit.

In FIG. 2, the working fluid 50 is in a closed cycle of the thermal energy storage system 40 and the coupling heat exchanger 48 is in series with a heating or cooling unit 54 that supplies the hot/cold duty when no energy is required from the thermal energy storage system.

In particular embodiments, the LNG production facility 12 may comprise several coupling heat exchangers (of which only one is shown in FIG. 2).

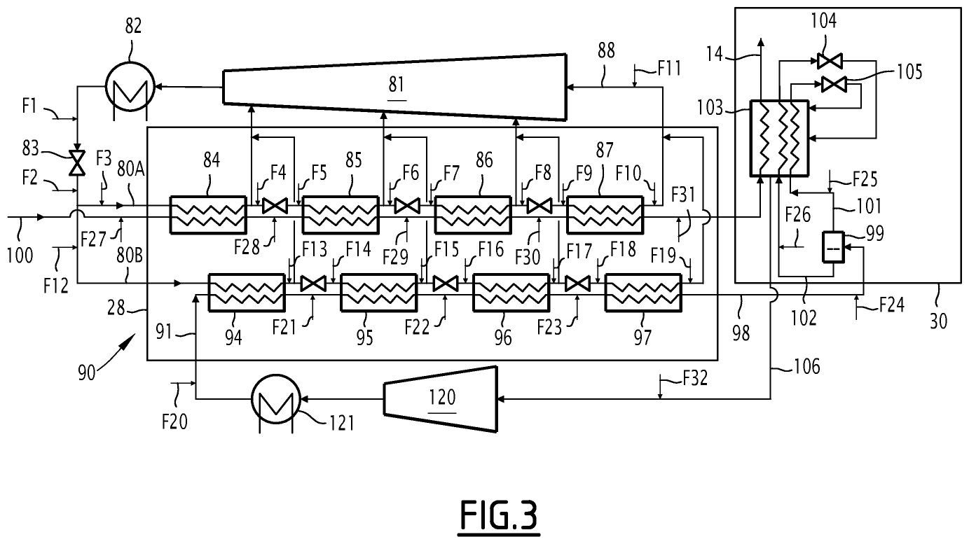

As shown in FIG. 3, the LNG production facility 12 advantageously comprises a refrigeration cycle 80, for example using propane, in order to bring cold at least to the precooling unit 28 to precool the natural gas 100 (purified feed gas) in a line 80A, and/or to bring cold to a refrigeration cycle 90, for example using a mixed refrigerant (MR), in a line 80B in order to cool the high pressure MR vapors 91 in the precooling unit 28, where the high pressure MR vapors 91 are partially condensed and subsequently send to the liquefaction unit 30 to liquefy and subcool the natural gas.

The precooling refrigerant propane is vaporized at typically four pressure levels. Purified natural gas 100 and MR 91 are cooled against the boiling refrigerant in parallel heat exchangers, as shown in FIG. 3. The propane refrigerant vapors, after having been compressed in a three-stage compressor 81, is condensed and subcooled by heat extraction in 82 prior to being divided into two streams, one for each parallel set of heat exchangers, let down in pressure in at least one expander 83 and partially vaporized in the high-pressure (HP, 84&94), medium-pressure (MP, 85&95) and low-pressure (LP, 86&96) exchangers while chilling the natural gas stream 100 and the MR 91. The vapor streams produced from each stage are combined and sent to the precooling propane compressor as HP, MP and LP side streams, while the liquid streams produced in each stage are let down in pressure and sent to the subsequent exchangers. The precooling fluid is fully vaporized in the final low-low pressure (LLP) exchanger (87&97), sent to a suction drum to remove any liquid, and subsequently sent to the suction of the precooling compressor.

After pre-cooling, the partially condensed mixed refrigerant 98 is separated in a high-pressure separator 99. The vapor 101 and liquid 102 streams pass through separate circuits in the MCHE 103 where they are further cooled, liquefied, and sub-cooled. The two sub- cooled streams are let down in pressure in 104 and 105, further reducing their temperatures and sent to the shell side of the MCHE 103, where providing refrigeration for liquefying and sub-cooling the natural gas into LNG 14. The vaporized mixed refrigerant is then recompressed, typically in a two or three-stage compressor 120 with intermediate cooling 121 (only one stage is shown on FIG. 3).

### Thermal Energy Storage System

The thermal energy storage (TES) system 40 is adapted, in the charge configuration, for storing at least a fraction 58 of the renewable electricity 20 as thermal energy, whether it is sensible heat or latent heat.

In the discharge configuration, the thermal energy storage (TES) system 40 is adapted for converting at least part of the stored thermal energy for example into the electricity 42, the heat 44 and the cold 46, and for supplying at least part of the electricity 42 to one or several of the units in 26, said heat 44 to one or several of the units 26, and said cold 46 to one or several of the units 26.

According to particular embodiments, in the discharge configuration, the thermal energy storage (TES) system is adapted for converting the stored thermal energy into only the electricity 42, only the heat 44 or only the cold 46, which are supplied to one or several of the units 26.

In other particular embodiments, in the discharge configuration, the thermal energy storage (TES) system is adapted for converting the stored thermal energy into only the electricity 42 and the heat 44, only the electricity 42 and the cold 46, or only the heat 44 and the cold 46, the two products being supplied to one or several of the units 26.

By “supplying heat”, it is meant that the thermal energy storage system 40 provides energy to one or several of the units 26 in order to heat a process fluid of said unit(s).

By “supplying cold”, it is meant that the thermal energy storage system 40 receives energy from one or several of the units 26 in order to cool down a process fluid of said unit(s). Such thermal energy storage (TES) systems are known in themselves.

A thermal energy storage (TES) system typically comprises a device for converting electrical energy into thermal energy, a device for storing converted thermal energy and optionally a device for converting the stored thermal energy into electricity.

The first device for converting electrical energy into thermal energy may be a heating system producing heat using the electricity received (for example one or more heating systems by electrical resistances, by one or more infrared emitters, by microwave heating, by induction heating or by any other heating system using electricity), a device operating according to an inverted Stirling cycle, an inverted Rankine cycle, an inverted Brayton cycle or any other suitable thermodynamic cycle, a compressor or a heat pump, in particular a vapor compression heat pump.

In one embodiment, the thermal energy storage (TES) system comprises a first device for converting electrical energy into thermal energy and said first energy conversion device comprises at least one device for electrical heating of a working fluid or a heat transfer medium.

In another embodiment, the energy storage system comprises a first device for converting electrical energy into thermal energy and said first energy conversion device comprises at least one compressor of a working fluid.

In another embodiment, the energy storage system comprises a first device for converting electrical energy into thermal energy and said energy conversion system comprises at least one compressor of a working fluid followed by a device for electrical heating of the working fluid or a heat-carrying medium. The electric heating device is therefore arranged downstream of the compressor with respect to the direction of circulation of the working fluid during a charging phase.

The second optional device for converting thermal energy into electrical energy can operate according to a Stirling cycle, a Rankine cycle, a Brayton cycle or any other appropriate thermodynamic cycle. It typically comprises an element for converting thermal energy into mechanical energy (e.g. a turbine) coupled to an element for converting mechanical energy into electrical energy (e.g. a generator).

It is possible to provide a thermal energy storage (TES) system of the reversible type, in which the first and second conversion devices have common components, in particular of the compressor/expander type. However, for better efficiency, it is preferable to provide separate first and second conversion devices, which do not share any components, in particular no components of the compressor/expander type.

Thermal energy storage (TES) systems usable in the present invention can be systems of the Carnot battery type, making it possible to receive electricity and to supply electricity. In a Carnot battery, electrical energy (incoming) is used to establish a temperature difference between two media. These media, one of which is at low temperature (LT) and the other at high temperature (HT), can be fluids (liquid or gaseous) or solids contained in storage devices (typically tanks), or only one of the media may be contained in a storage device, the other medium being ambient air. In this way, the storage device is charged, and electrical energy is stored as thermal energy. As heat flows against the thermal gradient, work is expended to charge the storage device. In the discharge phase, thermal energy is discharged by letting heat flow from the HT medium to the LT medium. The heat flow powers a heat engine which converts it to work and rejects the residual heat in the LT tank. In this way, a fraction of the electrical input is recovered.

These systems can however be used in the present invention to receive electricity and supply (at least temporarily or permanently) only thermal energy (cold or hot). They no longer meet the definition of a Carnot battery, but their operation is similar and their layout can remain identical, the components used to produce electricity can still be present or, on the contrary, eliminated.

It will be possible in particular to use thermal energy storage (TES) systems of the ETES type for “Electric Thermal Energy Storage”, of the PTES type for “Pumped Thermal Electricity Storage. It is also possible to use systems receiving external thermal energy via a fluid which is brought to useful temperatures using the electricity received for the storage of thermal energy, such as TI-ETES type systems for “Thermal Integrated ETES”, or of the TI-PTES type for “thermally Integrated PTES”, or even of the CHEST type for “Compressed Heat Energy Storage” which is a type of TI-PTES.

In an embodiment, the thermal energy storage (TES) system may include at least one hot thermal storage device and at least one cold thermal storage device. A so-called “hot” thermal storage device makes it possible to store thermal energy at a temperature higher than the so-called “cold” thermal storage device. This type of system can in particular be used to cover at least part of the heating and/or cooling needs of the installation.

The thermal energy storage (TES) device may be a latent heat (by phase change from solid to liquid or liquid to gas, or vice versa), sensible heat (by raising or lowering temperature of a liquid or a solid) or a combination of the two. It may include one or more thermally insulated storage tanks containing one or more heat transfer/refrigerant media.

The heat transfer/refrigerant medium can be a phase change material (also called PCM for “phase change material”), which is, in a known manner, a material which absorbs energy during heating during the phase change, by example of a solid to a liquid (or a liquid to a gas), and which releases energy into the adjacent environment during the reverse cooling process. For example, when heating solid-phase PCM, the solid increases in temperature (storage of sensible energy). During the phase change from a solid to a liquid, energy is stored latently. After the phase change to a liquid, the energy is again sensitively stored and the PCM in the liquid phase increases its temperature. Usable phase change materials include salts and mixtures of salts as well as water.

The heat/refrigerant medium can also be a gas, a liquid (in particular of low viscosity making it possible to obtain a continuous flow at the temperatures of use) or a solid (generally in the form of powders, particles or solid blocks having cavities and/or open channels) having appropriate thermal storage capacities and/or capable of achieving appropriate heat transfer rates for the intended use. Usable media include gases such as air, nitrogen, helium, neon, argon, hydrogen and krypton, carbon dioxide and water vapor. Other usable media include water, water mixed with one or more antifreeze compounds (e.g. ethylene glycol, propylene glycol or glycerol), hydrocarbons, such as, for example, alkanes (e.g. propane, butane, pentane, hexane, isohexane, heptane), alkenes (e.g. propylene, ethylene), alkynes, aldehydes, ketones, carboxylic acids (e.g. HCOOH), ethers, cycloalkanes, aromatic hydrocarbons, alcohols (e.g. ethanol, methanol, butanol), one or more other types of hydrocarbon molecules, or any combination thereof, ionic liquids, salts, eg potassium nitrate, calcium nitrate, sodium nitrate, sodium nitrite, lithium nitrate, alone or as a mixture, for example a mixture of sodium nitrate and potassium nitrate or an eutectic mixture of sodium nitrate and potassium nitrate, salt-water systems, in which the salts form hydrates, such as lithium bromide.

Most thermal energy storage (TES) systems use a working fluid for the operation of the conversion devices. Usable working fluids include air, argon, other noble gases, carbon dioxide, hydrogen, oxygen, or any combination thereof, and/or other fluids gaseous, liquid, critical or supercritical state (for example, supercritical CO2). The working fluid can be a gas or a low viscosity liquid (e.g. viscosity less than about 500·10⁻⁶ Poise at 1 atm). In some implementations, a gas having a specific heat ratio (the specific heat ratio, also called the adiabatic index, is the ratio of the heat capacity at constant pressure (Cp) to the heat capacity at constant volume (Cv)) can be used to achieve higher cycle efficiency than gas with low specific heat ratio. For example, argon (eg, specific heat ratio of about 1.66) can be used to replace air (e.g., specific heat ratio of about 1.4). In some cases, the working fluid can be a mixture of one, two, three or more fluids. In one example, helium (having high thermal conductivity and high specific heat) can be added to the working fluid (eg, argon) to improve heat transfer rates in heat exchangers.

Advantageously, the thermal energy storage (TES) system 40 is adapted, in the charge configuration, for receiving fatal heat 60 from at least one of the units 26.

By “fatal heat” it is meant a flow of heat coming from one of the units 26 at a rather low temperature, such as between 30° C. and 320° C., preferably between 50° C. and 280° C. In the prior art, fatal heat is usually evacuated in the environment, for example by heat exchange with cooling water or by air coolers and is therefore lost.

A non-exhaustive list of fatal heat sources in the LNG production facility 12 that can supply low temperature heat to the thermal energy storage system 40 are the following and are not shown in detail:
1. In the acid gas removal unit: Sweet Gas cooler, Amine regenerator condenser and Lean amine cooler,
2. In dehydration unit: Regeneration process fluid gas cooler,
3. In the propane refrigeration loop: Propane condensers and Propane subcooler,
4. In the MR refrigeration loop: the LP, MP and HP MR Compressor discharge cooler,
5. In the LPG recovery units: Depropaniser condenser and Debutaniser condenser,
6. In the end flash: Flash gas compressor MP Discharge cooler and Flash gas compressor HP Discharge cooler.

In a particular embodiment, the thermal energy storage (TES) system 40 is further adapted, in the discharge configuration, for converting at least part of the stored thermal energy into steam 64 and the installation 10 is adapted for providing said steam 64 to a steam turbine 66 of one of the units 26. For example, the steam turbine 66 is connected to one or several compressors (not shown) and provides them with mechanical power. It is preferable that the steam is at the highest pressure possible and superheated.

### Coupling Heat Exchanger(s)

The coupling heat exchanger 48 (or each of them) is adapted for performing a heat exchange between the working fluid 50 and the process fluid 52 for supplying said heat 44 or said cold 46 in the discharge configuration.

The coupling heat exchanger 48 (or each of them) is adapted for performing a heat exchange between the working fluid 50 and the process fluid 52 to receive the fatal heat 60 from one of the units 26 in the charge configuration.

The working fluid 50 may be a working fluid of a closed cycle in the thermal energy storage system 40. The process fluid 52 may be one of the refrigerant fluids or one of the natural gas components, including the regeneration gas used to regenerate the dehydration unit.

The appropriate location of the coupling exchanger 48 is a manner for the thermal energy storage system 40 to provide the heat 44 or the cold 46 to one of the units 26, or to receive the fatal heat 60 from one of the units 26.

For example, in the coupling heat exchanger 48 (FIG. 2), the process fluid 52 comes from the water removal (dehydration) unit 34, is a dried vapor comprising at least 90 vol % of methane and is intended to enter via line 53 a saturated drier (not shown). The process fluid 52 is heated against the working fluid 50, for example from 23.8° C. to 280° C., is then used for regenerating the drier (removing water from it).

A similar coupling heat exchanger 48 can be a heat exchanger for feed gas preheating (the process fluid is the feed gas) or a reboiler-type heat exchanger (the process fluid is the bottom product of the respective distillation column) for scrub column reboiling, seethaniser reboiling, sepropaniser reboiling, sebutaniser reboiling.

When sufficient renewable power is available, these heat-requiring units can be supplied with heat by an electrical heater 54 using electricity 70 from the renewable electricity facility 18. The electrical heater 54 heats the process fluid 52.

As an alternative, heat is produced in an electrical heater 56, for example located in a bypass line to the thermal energy storage system 40, in order to heat the working fluid 50. The fluid process 52 is heated in the coupling heat exchanger 48 by heat exchange with the working fluid 50.

In a particular embodiment, the process fluid 52 in the coupling heat exchanger 48 comes from the refrigeration cycle 80 and receives cold from the working fluid 50. The cold in the working fluid 50 is supplied to the refrigeration cycle 80 that precools the natural gas 100. This cooling (extraction of heat) can be done at several locations of the refrigeration cycle 80 shown by arrows F1 to F19 in FIG. 3: either downstream of compression 81, to help condensing and subcooling of refrigeration fluid after compression, either before or after the heat exchangers 84, 85, 86 and 87 on line 80A, either before or after letting down of the refrigerant fluid over the different expansion stages or upstream of the compressor 81, to reduce working fluid 88 volume to compress or both; and either before or after the heat exchangers 94, 95, 96 and 97 on line 80B. The arrows F1 to F19 symbolize cold supplied to the refrigerant of the refrigeration cycle 80 from the working fluid 50 (not shown in FIG. 3) at different locations via a coupling heat exchanger (not shown).

In another particular embodiment, the process fluid 52 in the coupling heat exchanger 48 comes from the refrigeration cycle 90 and receives cold from the working fluid 50. This cooling (extraction of heat) can be done at several locations of the refrigeration cycle 90 shown by arrows F12 to F26: either downstream of compression 120, to help condensing of the refrigeration fluid after compression, either before or after the heat exchangers 94, 95, 96 and 97, either before or after letting down the refrigerant fluid over the different expansion stages, either on the chilled vapor 101 and the chilled liquid 102 from the separator 99 or upstream of the compressor 120, to reduce working fluid 106 volume to compress or both. The installation 10 may then be devoid of the refrigeration cycle 80 using propane. The arrows F12 to F26 symbolize cold supplied to the refrigerant of the refrigeration cycle 90 from the working fluid 50 (not shown in FIG. 3) at different locations via a coupling heat exchanger (not shown).

In another particular embodiment, the process fluid 52 in the coupling heat exchanger 48 is the natural gas 100 and receives cold from the working fluid 50. This cooling can be done at several locations shown by arrows F27 to F31 in FIG. 3: either before or after the heat exchangers 84, 85, 86 and 87. The arrows F27 to F31 symbolize cold supplied to the natural gas 100 from the working fluid 50 at different locations via a coupling heat exchanger (not shown).

### Operation of the Installation

The operation of the installation 10 will now be described. It illustrates a process according to the invention.

The liquefied natural gas 14 is produced from the feed gas 16 using the LNG production facility 12. The installation 10 switches from the charge configuration, for example when there is sun or wind, to the discharge configuration, for example when there is no sun or no wind. For example, in the discharge configuration, the renewable electricity facility 18 does not produce or does not produce enough electricity for supplying the units 26.

In the charge configuration, the thermal energy storage system 40 receives at least the fraction 58 of the renewable electricity 20 and stores it as thermal energy. Another fraction 70 is supplied to one or several of the units 26.

In particular embodiments, a fraction of the renewable electricity 20 may be sent to the grid 24, or the LNG production facility 12 may receive electricity 25 from the grid.

Advantageously, the thermal energy storage system 40 also receives the fatal heat 60, which improves its global efficiency (amount of electricity 42 supplied during discharge divided by the amount of electricity 58 received during charge).

In the discharge configuration, the thermal energy storage system 40 converts the stored thermal energy into the electricity 42, the heat 44 and the cold 46 in the example, which are provided to the units in 26. In other embodiments, only one or two of these products are produced by the thermal energy storage system 40 and sent to the units 26.

For example, the heat 44 serves to heat the process fluid 52 going into the drier of the water removal unit 34. For example, the cold 46 is provided to the refrigeration cycle 80 using propane, or to the refrigeration cycle 90 using a mixed refrigerant.

Advantageously, the thermal energy storage (TES) system 40 also provides the steam 66 to the steam turbine 66.

### Advantages

Thanks to the above described features, one or several of the units in 26 receive(s) the electricity 42, the heat 44 and the cold 46 from the thermal energy storage (TES) system 40 in the discharge configuration. This electricity was stored as thermal energy in the charge configuration and has a renewable origin. As a consequence, the units 26 can be supplied with electricity having a renewable origin during times there is enough renewable electricity available and even when the renewable electricity facility 18 does not produce or does not produce enough electricity. This reduces the need for the additional electricity 25 coming from the grid 24 or for electricity produced locally using fossil fuels, thus allowing a better decarbonization of the LNG production facility 12.

The thermal energy storage (TES) system 40 not only stores renewable electricity 58, and but provides heat 44 and cold 46 to one or several of the units, thus improving their efficiency.

The optional feature according to which the thermal energy storage (TES) system 40 receives fatal heat 60 from the units in 26 allows increasing its efficiency.

1. An installation comprising an LNG production facility adapted for producing liquefied natural gas from a feed gas containing methane, and a renewable electricity facility adapted for producing renewable electricity, the LNG production facility comprising:
a plurality of units including a precooling unit, and a liquefaction unit, and
at least one thermal energy storage system adapted for storing electricity as thermal energy, and for converting at least part of the stored thermal energy into electricity, heat or cold,
wherein the installation is adapted for switching at least between a charge configuration, in which the renewable electricity facility produces said renewable electricity, at least a fraction of said renewable electricity is stored in the thermal energy storage system as thermal energy and at least another fraction is supplied to one or several of the units, and a discharge configuration, in which the thermal energy storage system converts at least part of the stored thermal energy into at least one of said electricity, said heat and said cold and said at least one of said electricity, said heat and said cold is supplied to one or several of the units.

2. The installation according to claim 1, wherein the thermal energy storage system is a Carnot battery and is adapted, in the discharge configuration, for converting at least part of the stored thermal energy into at least said electricity.

3. The installation according to claim 1, wherein the thermal energy storage system is adapted, in the charge configuration, for receiving fatal heat from at least one of said units.

4. The installation according to claim 1, wherein the thermal energy storage system is adapted, in the discharge configuration, for converting at least part of the stored thermal energy into steam and the installation is adapted for providing said steam to a steam turbine of one of said units.

5. The installation according to claim 1, further comprising at least one coupling heat exchanger connected to the thermal energy storage system for receiving a working fluid, and connected to at least one of said units for receiving a process fluid, the coupling heat exchanger being adapted for performing a heat exchange between the working fluid and the process fluid for supplying said heat or said cold.

6. The installation according to claim 5, wherein the plurality of units comprises a purification unit, a water removal unit, an acid gas removal unit and a fractionation unit, wherein, in the coupling heat exchanger, the process fluid comes from the purification unit, the water removal unit, the acid gas removal unit or the fractionation unit and receives the heat from the working fluid.

7. The installation according to claim 5, wherein the LNG production facility comprises a refrigeration cycle, for example using propane as a refrigerant, in order to bring cold at least to the precooling unit, wherein, in the coupling heat exchanger, the process fluid comes from said refrigeration cycle and receives the cold from the working fluid.

8. The installation according to claim 5, wherein the LNG production facility comprises a refrigeration cycle for example using a mixed refrigerant chilled in the precooling unit, in order to bring cold at least to the liquefaction unit, wherein, in the at least one coupling heat exchanger, the process fluid comes from said refrigeration cycle and receives the cold from the working fluid.

9. The installation according to claim 5, wherein, in the at least one coupling heat exchanger, the process fluid is natural gas obtained by purification of the feed gas, and receives the cold from the working fluid.

10. A process of producing liquefied natural gas from a feed gas containing methane, comprising:
providing providing an installation as described by claim 1,
producing producing the liquefied natural gas from the feed gas using the LNG production facility,
switching the installation at least between the charge configuration, and the discharge configuration.
